(19) United States
(12) Patent Application Publication
(10) Pub. No.: US 2020/0272136 A1
(43) Pub. Date: Aug. 27, 2020

(54) PRODUCTION SCHEDULE CHANGE SYSTEM, PRODUCTION SCHEDULE CHANGE METHOD, AND PRODUCTION SCHEDULE CHANGE PROGRAM

(71) Applicant: MITSUBISHI HEAVY INDUSTRIES, LTD., Tokyo (JP)

(72) Inventors: Takumi FUJITA, Tokyo (JP); Shoichi AOKI, Tokyo (JP); Hideaki NAGAI, Tokyo (JP)

(21) Appl. No.: 16/689,312

(22) Filed: Nov. 20, 2019

(30) Foreign Application Priority Data
Feb. 21, 2019 (JP) 2019-029115
Nov. 8, 2019 (JP) 2019-203008

(51) Int. Cl. G05B 19/418; G06Q 10/08

(52) U.S. Cl. CPC G05B 19/41865; G05B 19/4183; G05B 19/41875; G06Q 10/087; G05B 19/41855; G06Q 10/0832; G05B 19/41885

(57) ABSTRACT

A production schedule change system includes: a production schedule acquisition part configured to acquire a production schedule of a product in a case where the product is produced at an initial condition of production speed; a time information acquisition part configured to acquire time information indicating a scheduled collection time; and a schedule candidate calculation part configured to: change the production speed from the initial condition within a range defined by a quality standard of the product, based on the time information; and calculates at least one production schedule candidate satisfying a first condition that a time difference between a deliverable time of the product and the scheduled collection time is in an acceptable range and at least one of a second condition that the deliverable time is earlier than the scheduled collection time or a third condition that the scheduled collection time is earlier than the deliverable time.

### TECHNICAL FIELD

The present disclosure relates to a production schedule change system, a production schedule change method, and a production schedule change program.

### BACKGROUND ART

In a factory, a production schedule may be set as a guide for producing a product. The production schedule includes, for instance, a production order of a product and a scheduled time regarding the production order. The production schedule may be created and managed by a computer.

For instance, Patent Document 1 discloses a production management device that determines a delivery truck, a loading form to the delivery truck, and a shipping time based on order data, and creates a production schedule of corrugated cardboard based on the loading form and the shipping time.

### CITATION LIST

### Patent Literature

Patent Document 1: JP2008-210246A

### SUMMARY

The shipping time of the production schedule is only a rough time, and the actual scheduled collection time of a carrier (e.g., delivery truck) may vary depending on the situation. If collection by the carrier is delayed, resources (e.g., producer, production facility, product that has been produced and temporarily stored) of the factory have a waiting time. If collection by the carrier is advanced, the carrier has a waiting time.

Therefore, in order to effectively reduce both waiting times, it is necessary to flexibly change the production schedule in consideration of the scheduled collection time of the carrier that may vary depending on the situation, in addition to creating the production schedule base on the order data as disclosed in Patent Document 1. Such change is complicated for a person. Further, even if the production schedule is changed in consideration of the scheduled collection time of the carrier, a minimum quality of the product may not be obtained when the change is unreasonable.

In view of the above, at least one embodiment of the present invention is to provide a production schedule change system that can effectively reduce a waiting time of resources of a factory and a waiting time of a carrier, while ensuring a minimum quality of a product.

(1) A production schedule change system according at least one embodiment of the present invention comprises: a production schedule acquisition part configured to acquire a production schedule of a product in a case where the product is produced at an initial condition of production speed; a time information acquisition part configured to acquire time information indicating a scheduled collection time; and a schedule candidate calculation part configured to: change the production speed from the initial condition within a range defined by a quality standard of the product, based on the time information; and calculate at least one candidate of the production schedule satisfying a first condition that a time difference between a deliverable time of the product and the scheduled collection time is in an acceptable range and further satisfying at least one of a second condition that the deliverable time is earlier than the scheduled collection time or a third condition that the scheduled collection time is earlier than the deliverable time.

With the above configuration (1), a production schedule candidate satisfying the first condition and further satisfying at least one of the second condition or the third condition is calculated. In this case, by applying this candidate, it is possible to effectively reduce the waiting time of the resources of the factory and the waiting time of the carrier. Further, with the above configuration, the production speed is changed from the initial condition within a range defined by the quality standard, and the production schedule candidate is calculated. Thus, it is possible to ensure a minimum quality of the product.

(2) In some embodiments, in the above configuration (1), in a case where the production schedule includes a plurality of production orders of the product, the schedule candidate calculation part selects a production order that changes the production speed, based on priority in accordance with sensitivity information indicating sensitivity of quality of the product to the production speed for each type of the product.

With the above configuration (2), since the production order that changes the production speed is selected based on priority in accordance with the sensitivity information, it is possible to efficiently calculate the production schedule candidate, and it is possible to easily ensure the quality of the product.

(3) In some embodiments, in the above configuration (2), in the case where the production schedule includes the plurality of production orders of the product, if the time difference is out of the acceptable range and the scheduled collection time is earlier than the deliverable time, the schedule candidate calculation part preferentially increases the production speed of a production order of the product having a low sensitivity among the plurality of production orders, recalculates the deliverable time, and calculates a candidate of the production schedule satisfying at least one of the first condition or the second condition.

With the above configuration (3), since the production speed of the production order of the product having a low sensitivity is preferentially increased, it is possible to prevent a reduction in quality due to an increase in production speed.

(4) In some embodiments, in the above configuration (2) or (3), in the case where the production schedule includes the plurality of production orders of the product, if the time difference is out of the acceptable range and the scheduled collection time is later than the deliverable time, the schedule candidate calculation part preferentially decreases the production speed of a production order of the product having a high sensitivity among the plurality of production orders, recalculates the deliverable time, and calculates a candidate of the production schedule satisfying at least one of the first condition or the third condition.

With the above configuration (4), since the production speed of the production order of the product having a high sensitivity is preferentially decreased, it is possible to improve the quality with a decrease in production speed.

(5) In some embodiments, in any one of the above configurations (2) to (4), the schedule candidate calculation part acquires the sensitivity information stored in a database and calculates a candidate of the production schedule.

With the above configuration (5), since the sensitivity information stored in the database is used, it is possible to increase the speed of processing, and it is possible to improve responsiveness to a change in the scheduled collection time. In particular, it is advantageous in reviewing the production schedule in real time.

(6) In some embodiments, in any one of the above configurations (2) to (4), the production schedule change system comprises: a quality prediction model generation part configured to generate a quality prediction model for predicting quality of the product in relation to the production speed, based on record information of a previous production order; and a sensitivity information generation part configured to generate or update the sensitivity information using the generated quality prediction model. The record information includes information about a production speed at which the product has been produced and quality of the product.

With the above configuration (6), even if the sensitivity information is not generated or needs to be updated, it is possible to generate or update the sensitivity information by using the quality prediction model generated based on the record information of a previous production order.

(7) In some embodiments, in the above configuration (6), the record information further includes at least one of facility information about a production facility that has produced the product, environmental information about an external environment under which the product has been produced, or product information about the product.

With the above configuration (7), since the record information including various information is used, more accurate sensitivity information is generated, and the production schedule candidate can be calculated using this sensitivity information.

(8) In some embodiments, in any one of the above configurations (1) to (7), the production schedule change system comprises a quality prediction part configured to predict quality of the product in a case where the production speed of a production order included in the production schedule is changed, based on record information of a previous production order of the product. The record information includes information about a production speed at which the product has been produced and quality of the product. The schedule candidate calculation part causes the quality prediction part to predict quality of the product in a case where the production speed of the production order of the product included in the production schedule is changed from the initial condition, and calculates the production schedule based on the production speed changed based on a prediction result as the at least one candidate.

With the above configuration (8), even not using information such as upper limit speed, lower limit speed, and sensitivity, it is possible to calculate a production schedule candidate satisfying the first condition and further satisfying at least one of the second condition or the third condition. However, the system may be configured to use information such as upper limit speed, lower limit speed, and sensitivity to improve efficiency and speed of processing.

(9) In some embodiments, in any one of the above configurations (1) to (8), the production schedule change system comprises a search processing part configured to search for a range of the production speed defined by the quality standard of the product, using a quality prediction model for predicting quality of the product in relation to the production speed.

With the above configuration (9), even if the range of the production speed defined by the quality standard of the product is not set, the range can be set by the search processing. Further, since the range of the production speed is searched using the quality prediction model, it is possible to improve efficiency and speed of the search processing.

(10) In some embodiments, in any one of the above configurations (1) to (9), the production schedule is a production schedule for producing corrugated cardboard by a paper converting machine, and the quality standard of the product includes a standard based on at least one quality index of warpage of the corrugated cardboard in a bonded state, folding misalignment of the corrugated cardboard, printing misalignment of the corrugated cardboard, or damage to the corrugated cardboard.

Generally, in the production of corrugated cardboard, various types of products are produced by one production line. Further, the production speed often affects the quality of the products. Corrugated cardboard is expensive to transport compared to product production costs and product prices. Thus, with the above configuration (10), it is possible to more effectively take advantage of the production schedule change system that reduces waste related to transportation. Further, it is possible to calculate a production schedule candidate taking into consideration a quality index such as warpage, folding misalignment, printing misalignment, and damage important to the production of corrugated cardboard.

(11) In some embodiments, in the above configuration (1), if no candidate of the production schedule satisfying the first condition is found, the schedule candidate calculation part calculates a candidate that minimizes the time difference between the deliverable time and the scheduled collection time within a range of the production speed defined by the quality standard of the product.

With the above configuration (11), it is possible to effectively reduce the waiting time of the resources of the factory and the waiting time of the carrier, while ensuring quality of the product satisfying the quality standard.

(12) A production schedule change method according at least one embodiment of the present invention comprises: a production schedule acquisition step of acquiring a production schedule of a product in a case where the product is produced at an initial condition of production speed; a time information acquisition step of acquiring time information indicating a scheduled collection time; and a schedule candidate calculation step of: changing the production speed from the initial condition within a range defined by a quality standard of the product, based on the time information; and calculating at least one candidate of the production schedule satisfying a first condition that a time difference between a deliverable time of the product and the scheduled collection time is in an acceptable range and further satisfying at least one of a second condition that the deliverable time is earlier than the scheduled collection time or a third condition that the scheduled collection time is earlier than the deliverable time.

With the above method (12), a production schedule candidate satisfying the first condition and further satisfying at least one of the second condition or the third condition is calculated. In this case, by applying this candidate, it is possible to effectively reduce the waiting time of the resources of the factory and the waiting time of the carrier. Further, with the above method (11), the production speed is changed from the initial condition within a range defined by the quality standard, and the production schedule candidate is calculated. Thus, it is possible to ensure a minimum quality of the product.

(13) A production schedule change program according at least one embodiment of the present invention is configured to cause a computer to function as a production schedule acquisition unit configured to acquire a production schedule of a product in a case where the product is produced at an initial condition of production speed; a time information acquisition unit configured to acquire time information indicating a scheduled collection time; and a schedule candidate calculation unit configured to: change the production speed from the initial condition within a range defined by a quality standard of the product, based on the time information; and calculate at least one candidate of the production schedule satisfying a first condition that a time difference between a deliverable time of the product and the scheduled collection time is in an acceptable range and further satisfying at least one of a second condition that the deliverable time is earlier than the scheduled collection time or a third condition that the scheduled collection time is earlier than the deliverable time.

With the above program (13), the computer calculates a production schedule candidate satisfying the first condition and further satisfying at least one of the second condition or the third condition. In this case, by applying this candidate, it is possible to effectively reduce the waiting time of the resources of the factory and the waiting time of the carrier. Further, in the above program (12), the computer changes the production speed from the initial condition within a range defined by the quality standard and calculates the production schedule candidate. Thus, it is possible to ensure a minimum quality of the product.

According to at least one embodiment of the present invention, it is possible to effectively reduce the waiting time of the resources of the factory and the waiting time of the carrier, while ensuring a minimum quality of the product.

### BRIEF DESCRIPTION OF DRAWINGS

FIG. 1 is a schematic configuration block diagram of a production schedule change system according to an embodiment.

FIG. 2 is a diagram showing an example of sensitivity information used in a production schedule change system according to an embodiment.

FIG. 3 is a conceptual diagram for describing an example of search processing of a production schedule change system according to an embodiment.

FIG. 4 is a conceptual diagram for describing an example of search processing of a production schedule change system according to an embodiment.

FIG. 5 is a flowchart showing an example of search processing of a production schedule change system according to an embodiment.

FIG. 6 is a flowchart showing an example of production schedule candidate calculation processing executed by a production schedule change system according to an embodiment.

FIG. 7 is a schematic configuration block diagram of a production schedule change system according to an embodiment.

FIG. 8 is a flowchart showing an example of production schedule candidate calculation processing executed by a production schedule change system according to an embodiment.

FIG. 9 is a schematic diagram for describing an example of use of a production schedule change system according to an embodiment.

FIG. 10 is a conceptual diagram showing an example of production management using a production schedule change system according to an embodiment.

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of an equal state such as “same” “equal” and “uniform” shall not be construed as indicating only the state in which the feature is strictly equal, but also includes a state in which there is a tolerance or a difference that can still achieve the same function.

On the other hand, an expression such as “comprise”, “include”, “have”, “contain” and “constitute” are not intended to be exclusive of other components.

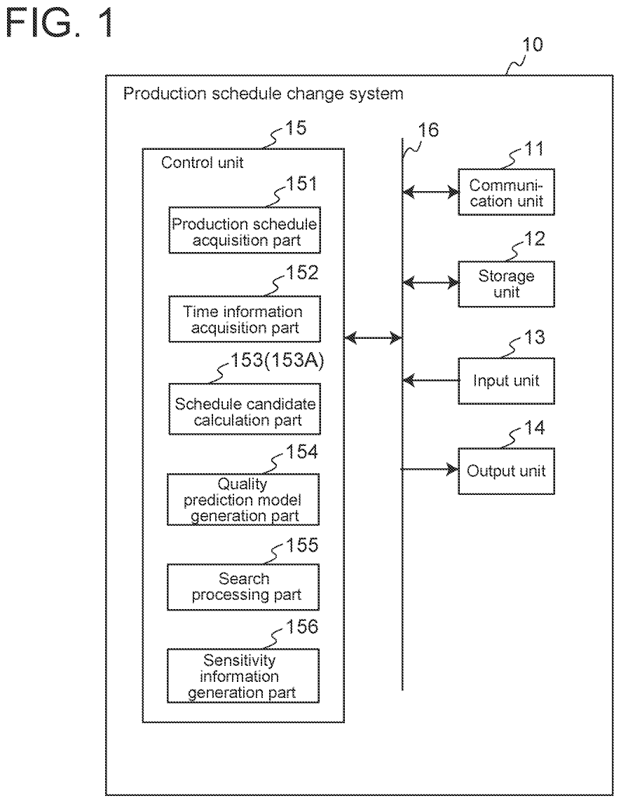

FIG. 1 is a schematic configuration block diagram of a production schedule change system 10 according to an embodiment of the present invention.

The production schedule change system 10 is a system for calculating a candidate of a production schedule in which the production speed of a production facility is changed. The production facility is a facility for producing a product. For instance, when the product is corrugated cardboard, the production facility is a paper converting machine such as a corrugator and a case former.

The production schedule change system 10 includes at least one computer. The production schedule change system 10 includes, for instance, a communication terminal device such as a personal computer, a tablet device, or a smartphone, and a server device. The following example will be described with respect to the production schedule change system 10 which is a communication terminal device.

The production schedule change system 10 is not limited to the following example. The production schedule change system 10 may include a plurality of communication terminal devices and server devices, and may implement a function through cooperation of these devices. The production schedule change system 10 may be integrally incorporated in a production management system for managing a production schedule of a factory. Alternatively, the production schedule change system 10 may be separate from the production management system and may be communicably connected to the production management system.

As shown in FIG. 1, the production schedule change system 10 includes a communication unit 11 configured to communicate with another device, a storage unit 12 configured to store various data, an input unit 13 configured to receive an input from the user, an output unit 14 configured to output information to the user, and a control unit 15 configured to control the entire device. These components are connected to each other by a bus line 16.

The communication unit 11 is a communication interface including a network interface card controller (NIC) for wire communication or wireless communication. The communication unit 11 establishes communication with another device via a network such as world area network (WAN) and local area network (LAN).

The storage unit 12 includes, for instance, a random access memory (RAM) and a read only memory (ROM). The storage unit 12 stores a program (e.g., production schedule change program) for executing various control processing and various data.

The input unit 13 includes, for instance, an input device such as an operation button, a keyboard, a pointing device, and a microphone. The input unit 13 is an input interface used for the user (e.g., manager or worker in the factory) to input an instruction.

The output unit 14 includes, for instance, an output device such as a liquid crystal display (LCD), an electroluminescence (EL) display, and a speaker. The output unit 14 is an output interface for providing various information (e.g., calculation result of candidate of production schedule) to the user.

The control unit 15 includes, for instance, a processor such as a central processing unit (CPU) and a graphics processing unit (GPU). The control unit 15 controls the operation of the entire system by executing a program stored in the storage unit 12.

A functional configuration of the control unit 15 will now be described. The control unit 15 functions as a production schedule acquisition part 151, a time information acquisition part 152, a schedule candidate calculation part 153 (153A), a quality prediction model generation part 154, a search processing part 155, and a sensitivity information generation part 156.

The production schedule acquisition part 151 acquires a production schedule of a product in a case where the product is produced at an initial condition of production speed. For instance, when the production schedule change system 10 is separate from the production management system, the production schedule acquisition part 151 may acquire the production schedule through communication with the production management system via the communication unit 11. When the production schedule change system 10 is integrated with the production management system, the production schedule acquisition part 151 may acquire the production schedule by referring to the storage unit 12.

The initial condition of production speed is a condition of production speed that is a basis for calculating a deliverable time of the product in a current production schedule. For instance, the initial condition of production speed may a set value of the production speed currently set in the production facility, or may be a rated value of the production speed of the production facility.

The production speed may be information indicating the number of products that can be produced per unit time, for instance. However, the production speed is not limited to such information, but may be information indicating the moving speed of a substance on a production line that proceeds in the production process. For instance, in a case where corrugated cardboard is produced, the production speed of the corrugator or the case former may be the moving speed of a sheet per minute. Alternatively, the production speed may not be information indicating the speed, but may be information about the current or the voltage of the production facility or the rotational speed of a motor in relation to the production speed.

The time information acquisition part 152 acquires time information indicating a scheduled collection time. For instance, when the user is informed of a scheduled collection time by the carrier and inputs the scheduled collection time via the input unit 13 to the time information acquisition part 152, the time information acquisition part 152 may acquire the input information as the time information. The time information acquisition part 152 may acquire the time information through communication with another device via the communication unit 11. This device may be a delivery management sever for managing the delivery status (e.g., scheduled collection time, moving status, departure status) of the carrier, a communication terminal carried by the carrier, or an in-vehicle device mounted to a delivery truck.

Further, the time information acquisition part 152 may indirectly acquire the time information by acquiring information that is basis for calculating the scheduled collection time via the communication unit 11 or the input unit 13 and computing the time information using this information. For instance, the time information acquisition part 152 may acquire positional information about the delivery truck via the communication unit 11 and acquire a scheduled collection time estimated from the positional information as the time information. For instance, the time information acquisition part 152 may acquire information about the departure time of the delivery truck via the communication unit 11 and acquire a scheduled collection time estimated from the information as the time information.

The schedule candidate calculation part 153 (153A) calculates at least one production schedule candidate satisfying a first condition as an alternative to reduce the waiting times of both the carrier and the resources of the factory. The first condition is a condition that the time difference between the deliverable time and the scheduled collection time of the product is in an acceptable range. More specifically, the schedule candidate calculation part 153 (153A) changes the production speed from the initial condition within a range defined by the quality standard of the product, based on the time information acquired by the time information acquisition part 152, and calculates at least one production schedule candidate in which the delay of the deliverable time relative to the scheduled collection time and the delay of the scheduled collection time relative to the deliverable time of the product are both in an acceptable range.

The calculated production schedule may be reflected in the production schedule as it is, or may be first provided to the user and then reflected in the production schedule depending on the user's determination. In other words, the production schedule change system 10 may be configured to directly change the production schedule, or may be configured to merely output the candidate but not to directly change the production schedule. If a candidate that can reduce the waiting time into the acceptable range is not found, the production schedule change system 10 may output such a result or may output a candidate that can reduce the waiting time to some extent.

That is, the expression “calculating a production schedule candidate satisfying the first condition” does not necessarily mean that a candidate satisfying the first condition is obtained, but does mean that an operation for finding a candidate satisfying the first condition is executed. The same applies to the expression “calculating” a production schedule candidate satisfying a second condition or a third condition described later.

The quality standard of the product is a minimum quality index set based on knowledge of the producer or law. The quality index may be a numerical value if the quality can be quantified, or may be a criterion for determining the quality (for instance, the presence or absence of damage) if the quality cannot be quantified.

The quality of the product may vary with the production speed. For instance, in the production of corrugated cardboard by a paper converting machine (corrugator, case former), the quality of corrugated cardboard varies with the production speed of the paper converting machine. The influence of the production speed on the quality of the product (i.e., sensitivity of quality to production speed) varies with the type of the product.

For instance, the corrugator heats a front sheet and a back sheet for bonding them. If the production speed is too high, the front sheet and the back sheet cannot be uniformly heated, so that a difference may occur in the amount of elongation of these sheets due to moisture absorption after the temperature drops, and warpage occurs in a bonded state. For instance, the case former prints and folds a corrugated cardboard sheet produced by the corrugator. If the production speed is too high in these steps, the actual position of the sheet may be misaligned with the target position for printing and folding, and the sheet cannot be accurately printed and folded. The case former finally stacks the resulting corrugated cardboard boxes. If jam occurs in the middle of this step, the contiguous corrugated cardboard boxes are pressed to each other and may be damaged.

Thus, in the production of corrugated cardboard, the quality standard of the product preferably includes a standard based on at least one quality index of warpage of the corrugated cardboard in a bonded state, folding misalignment of the corrugated cardboard, printing misalignment of the corrugated cardboard, or damage to the corrugated cardboard.

The acceptable range of the delay may be set based on a waiting time acceptable to the producer or the carrier themselves, or may be predetermined (e.g., 1 hour, 15 minutes, or 5 minutes) based on knowledge of the provider of the production schedule change system 10. The acceptable range is preferably within 1 hour. Further, the acceptable range may differ between the delay of the deliverable time relative to the scheduled collection time and the delay of the scheduled collection time relative to the deliverable time of the product. For instance, the former may be 15 minutes, and the latter may be 30 minutes.

The schedule candidate calculation part 153 (153A) executes a schedule candidate calculation processing. More specifically, in a case where the production schedule includes a plurality of production orders of the product, the schedule candidate calculation part 153 (153A) selects a production order that changes the production speed, based on priority in accordance with sensitivity information indicating sensitivity of quality of the product to the production speed for each type of the product.

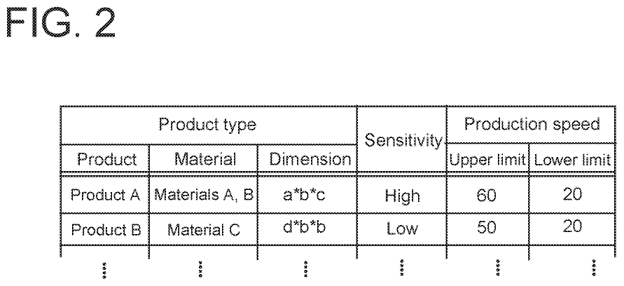

The sensitivity information will now be described. FIG. 2 is a diagram showing an example of the sensitivity information used in the production schedule change system 10 according to an embodiment. As shown in FIG. 2, the sensitivity information is information that associates information indicating a product type, sensitivity of the product type, and information indicating a production speed at which the product type is produced.

As shown in FIG. 2, the information indicating the product type may include information such as product name and the material and the dimension of the product, or may be merely identification information indicating the product type. For instance, when the product is corrugated cardboard, the information indicating the product type may include information indicating the product name of the corrugated cardboard, the paper type of a front liner, the grammage of the front liner, the paper type of a corrugated medium, the grammage of the corrugated medium, the paper type of a back liner, and the grammage of the back liner.

As shown in FIG. 2, the information indicating sensitivity may be information indicating the level of sensitivity classified according to the magnitude of sensitivity, for instance, into high (high sensitivity), moderate (moderate sensitivity), and low (low sensitivity), or may be information indicating a numerical value of the magnitude of sensitivity. In the sensitivity information, as shown in FIG. 2, the information indicating the production speed may be information indicating an upper limit value and a lower limit value of the production speed used for calculating sensitivity, or may be information indicating the production speed (e.g., upper limit value, lower limit value, rated value) used when the production speed is changed.

Further, the information indicating sensitivity may be a value obtained by dividing a difference between qualities obtained at the upper limit and the lower limit of the production speed set by a later-described search processing by a difference between the upper limit and the lower limit of the production speed, or may be a level according to this value. The information indicating sensitivity may not be information obtained by simple division of these differences but may be a result of statistical analysis of change in quality predicted in relation to the production speed. For instance, the information indicating sensitivity may be acquired by analyzing normality, correlation, outliers, or the like.

The quality prediction model generation part 154 shown in FIG. 1 generates a quality prediction model based on record information of a previous production order. The quality prediction model generation part 154 generates the quality prediction model by applying machine learning such as regression analysis to the record information, for instance. The record information may be input by the user via the input unit 13 or may be acquired from another device (e.g., production facility that stores the history of operation information, or management device of the production facility) via the communication unit 11.

The record information is information indicating a previous record and includes information about a production speed at which the product has been produced and the quality of that product. The record information may further include at least one of facility information about a production facility that has produced the product, environmental information about an external environment under which the product has been produced, or product information about the product. The facility information may be, for instance, identification information and setting information about the facility. The external environment may be temperature, humidity, and weather. The product information may be, for instance, information indicating the product type.

The search processing part 155 performs search processing. More specifically, the search processing part 155 searches for a range of the production speed defined by the quality standard of the product by using the quality prediction model generated by the quality prediction model generation part 154.

The sensitivity information generation part 156 generates or updates the sensitivity information by using the quality prediction model generated by the quality prediction model generation part 154. As described later, the sensitivity information generation part 156 may generate the sensitivity information based on the upper limit and the lower limit of the range of the production speed searched by the search processing part 155 and prediction results of quality at the upper limit and the lower limit of the production speed.

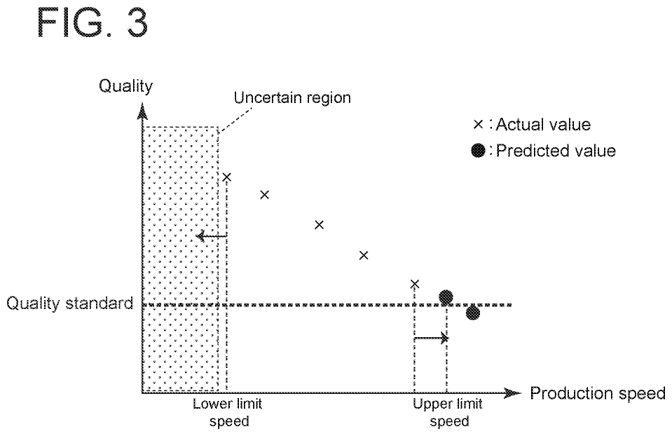

In the following, two examples of the search processing performed by the search processing part 155 will be described with reference to FIGS. 3 to 5.

In the first example of the search processing, a maximum speed and a minimum speed are defined as reference speeds (starting points), and the search processing is performed based on the two reference speeds. The maximum speed and the minimum speed may be a maximum speed and a minimum speed of a previous production speed (actual value) included in the record information. In other words, in this example, results of reviewing the maximum speed and the minimum speed of the previous production speed are used as the upper limit and the lower limit of the production speed. In the search processing for updating the sensitivity information, the upper limit and the lower limit based on previous sensitivity information may be used as the reference speeds.

FIG. 3 is a conceptual diagram for describing an example of the search processing of the production schedule change system 10 according to an embodiment. In the graph of FIG. 3, the horizontal axis represents the production speed, and the vertical axis represents the degree of quality. A prediction result of the actual value may be an actual quality obtained at an actual production speed as it is.

If the quality of the prediction result predicted at the minimum speed of the actual value is uncertain, the search processing part 155 increases the speed to search for the lower limit speed. If the quality of the prediction result predicted at the minimum speed of the actual value is not uncertain, the search processing part 155 decreases the speed to search for the lower limit speed. Being uncertain means that prediction result cannot be determined, i.e., means a limit on the prediction accuracy, and for instance, means that the accuracy rate is not more than a predetermined value. In searching, the search processing part 155 changes the speed stepwise by a certain amount.

If the quality of the prediction result predicted at the maximum speed of the actual value does not fall below the quality standard, the search processing part 155 increases the speed to search for the upper limit speed. If the quality of the prediction result predicted at the maximum speed of the actual value falls below the quality standard, the search processing part 155 decreases the speed to search for the upper limit speed. In searching, the search processing part 155 changes the speed stepwise by a certain amount.

In the example shown in FIG. 3, although the quality prediction result at the minimum speed is not uncertain, the quality prediction result at a speed decreased from the minimum speed by a certain amount is uncertain. In this case, the minimum speed is set as the lower limit speed. Further, in the example shown in FIG. 3, the quality prediction result at the maximum speed does not fall below the quality standard, and the quality prediction result at a speed increased from the maximum speed by a certain amount also does not fall below the quality standard, but the quality prediction result at a speed further increased by a certain amount falls below the quality standard. In this case, the speed immediately before the last speed that falls below the quality standard is set as the upper limit speed.

In the second example, one production speed is defined as a reference speed (starting point) to search for the upper limit and the lower limit of the production speed. The production speed defined as the reference speed may be a previous production speed according to the record information, a current set speed, a rated speed, or an average of previous production speeds.

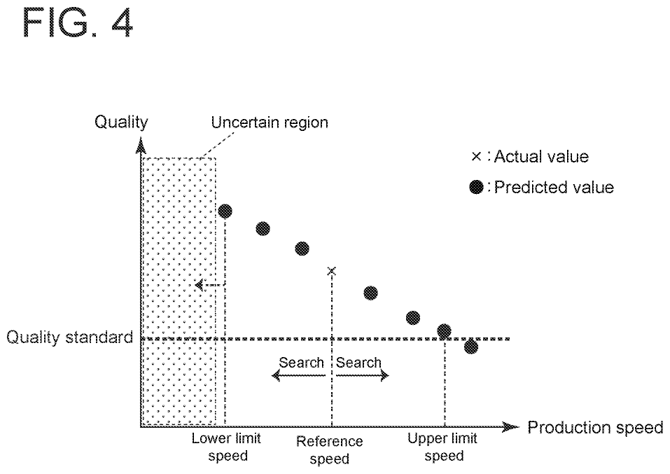

FIG. 4 is a conceptual diagram for describing an example of the search processing of the production schedule change system 10 according to an embodiment. In the graph of FIG. 4, the horizontal axis represents the production speed, and the vertical axis represents the degree of quality. A prediction result of the actual value may be an actual quality obtained at an actual production speed as it is, or may be a prediction result predicted at the actual production speed. Although in this example, the reference speed is the actual value of a previous production speed, the reference speed is not limited to the actual value as described above.

For searching for the lower limit speed, the search processing part 155 repeatedly predict quality while gradually decreasing the speed from the reference speed until the quality of the prediction result becomes uncertain. A speed immediately before the quality of the prediction result becomes uncertain is set as the lower limit speed. In searching, the speed is changed stepwise by a certain amount.

For searching for the upper limit speed, the search processing part 155 repeatedly predict quality while gradually increasing the speed from the reference speed until the quality of the prediction result falls below the quality standard. A speed immediately before the quality of the prediction result falls below the quality standard is set as the upper limit speed. In searching, the speed is changed stepwise by a certain amount.

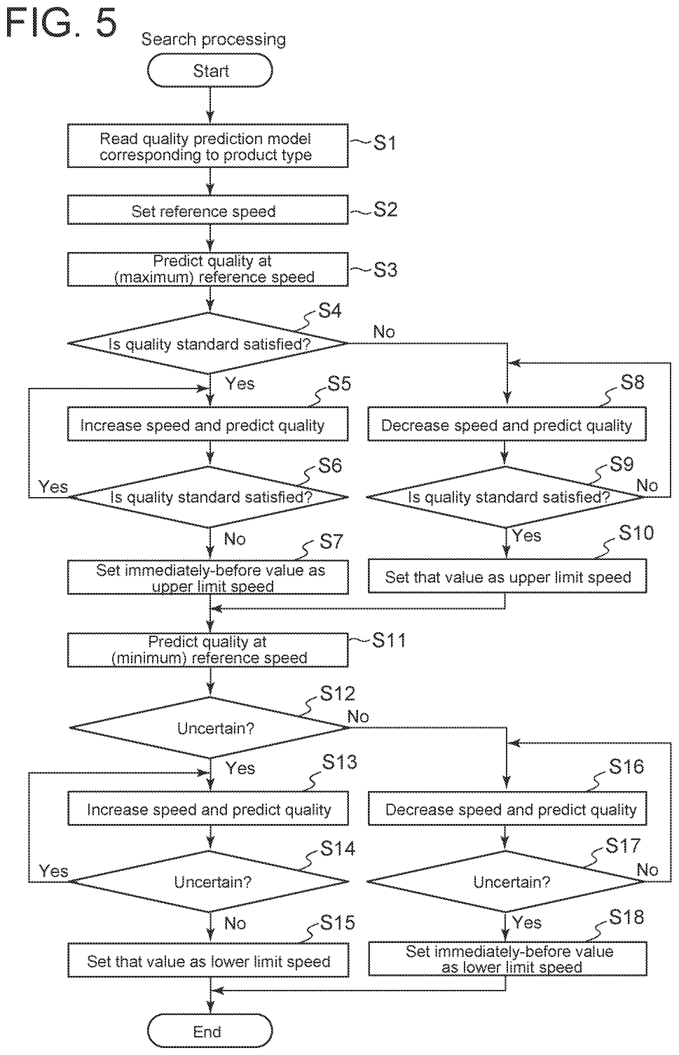

Here, the search processing will be described in detail with reference to a flowchart showing a procedure common to the two examples of the search processing. FIG. 5 is a flowchart showing an example of the search processing of the production schedule change system 10 according to an embodiment.

The search processing part 155 reads a quality prediction model corresponding to the product type for which the upper limit and the lower limit of the production speed is to be determined (step S1). The read quality prediction model is generated by the quality prediction model generation part 154 and stored in the storage unit 12.

The search processing part 155 sets the reference speed (step S2). For instance, each of the maximum speed and the minimum speed may be set as the reference speed. In this case, there are two reference speeds. Alternatively, one production speed may be set as a common reference speed. In this case, there is one reference speed.

The search processing part 155 predicts the quality when the reference speed is applied, using the quality prediction model (step S3). For instance, when there are two reference speeds, the quality is predicted at the maximum speed, and when there is one reference speed, the quality is predicted at that reference speed. The search processing part 155 determines whether the quality of the prediction result satisfies the quality standard (step S4). Whether the quality satisfies the quality standard means whether it falls below the quality standard.

In step S4, if the quality of the prediction result satisfies the quality standard (step S4; Yes), the quality when the production speed is increased by a certain amount is predicted (step S5), and it is determined whether the predicted quality satisfies the quality standard (step S6). If the quality of the prediction result satisfies the quality standard (step S6; Yes), the procedure returns to step S5. Conversely, if the quality of the prediction result does not satisfy the quality standard (step S6; No), the value immediately before is set as the upper limit speed (step S7).

In step S4, if the quality of the prediction result does not satisfy the quality standard (step S4; No), the quality when the production speed is decreased by a certain amount is predicted (step S8), and it is determined whether the predicted quality satisfies the quality standard (step S9). If the quality of the prediction result does not satisfy the quality standard (step S9; No), the procedure returns to step S8. Conversely, if the quality of the prediction result satisfies the quality standard (step S9; Yes), this value is set as the upper limit speed (step S10).

Then, the search processing part 155 predicts the quality when the reference speed is applied, using the quality prediction model (step S11). For instance, when there are two reference speeds, the quality is predicted at the minimum speed, and when there is one reference speed, the quality is predicted at that reference speed. The search processing part 155 determines whether the quality of the prediction result is uncertain (step S12).

In step S12, if the quality of the prediction result is uncertain (step S12; Yes), the quality when the production speed is increased by a certain amount is predicted (step S13), and it is determined whether the predicted quality is uncertain (step S14). If the quality of the prediction result is uncertain (step S14; Yes), the procedure returns to step S13. Conversely, if the quality of the prediction result is not uncertain (step S14; No), this value is set as the lower limit speed (step S15).

In step S12, if the quality of the prediction result is not uncertain (step S12; No), the quality when the production speed is decreased by a certain amount is predicted (step S16), and it is determined whether the predicted quality is uncertain (step S17). If the quality of the prediction result is not uncertain (step S17; No), the procedure returns to step S16. Conversely, if the quality of the prediction result is uncertain (step S17; Yes), the value immediately before is set as the lower limit speed (step S18).

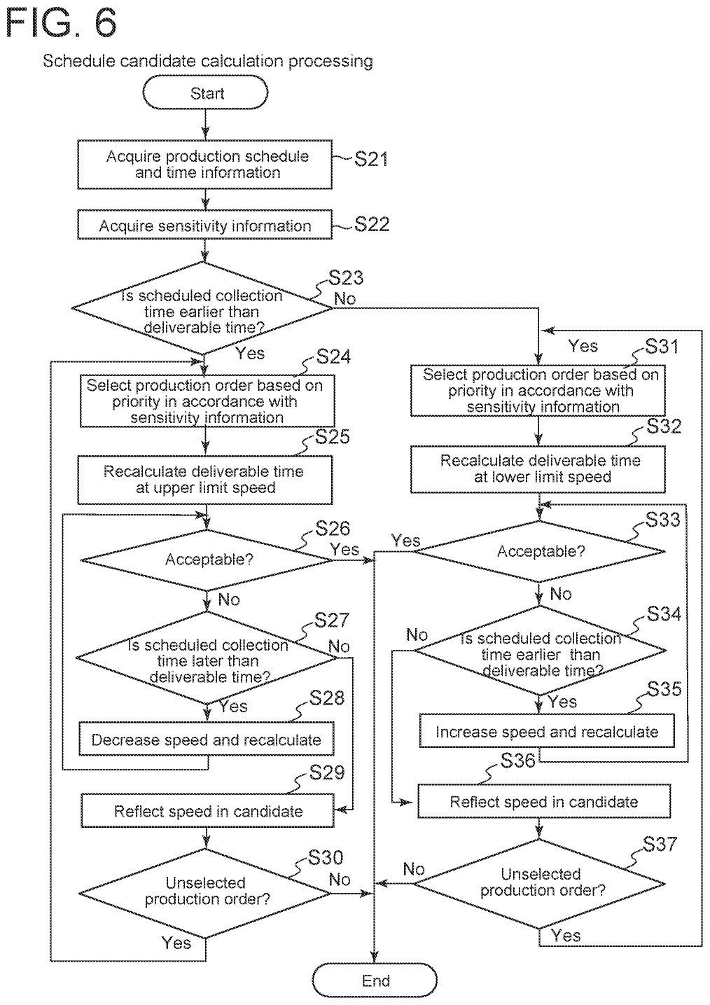

The schedule candidate calculation processing executed by the schedule candidate calculation part 153 (153A) will be described with reference to FIG. 6. FIG. 6 is a flowchart showing an example of the production schedule candidate calculation processing executed by the production schedule change system 10 according to an embodiment.

The schedule candidate calculation part 153 (153A) causes the production schedule acquisition part 151 to acquire a current production schedule (i.e., production schedule when the product is produced at production speed of initial condition), and causes the time information acquisition part 152 to acquire time information indicating the latest scheduled collection time (step S21). Further, the schedule candidate calculation part 153 (153A) acquires sensitivity information (step S22). The acquired sensitivity information is previously generated by the sensitivity information generation part 156 and stored in the storage unit 12.

The schedule candidate calculation part 153 (153A) determines whether the scheduled collection time according to the time information is earlier than the deliverable time according to the current production schedule (step S23).

In step S23, if it is determined that the scheduled collection time is earlier than the deliverable time (step S23; Yes), the schedule candidate calculation part 153 (153A) selects a production order based on priority in accordance with the sensitivity information (step S24). For instance, in a case where the production schedule includes a plurality of production orders of the product, a production order of the product having a low sensitivity is preferentially selected. The schedule candidate calculation part 153 (153A) recalculates the deliverable time when the production speed of the selected production order is the upper limit speed included in the sensitivity information (step S25).

Here, the schedule candidate calculation part 153 (153A) determines whether both the delay of the deliverable time relative to the scheduled collection time and the delay of the scheduled collection time relative to the deliverable time (i.e., time difference between the deliverable time and the scheduled collection time) are in an acceptable range (step S26). That is, in step S26, it is determined whether the first condition is satisfied. In step S26, if it is determined that both delays are in an acceptable range (step S26; Yes), the upper limit speed is reflected in a production schedule candidate, and the procedure ends.

In step S26, if it is determined that at least one of the two delays is out of an acceptable range (step S26; No), the schedule candidate calculation part 153 (153A) determines whether the scheduled collection time is later than the deliverable time (step S27). That is, it is determined whether the change amount of the production speed is too large.

If it is determined that the scheduled collection time is later than the deliverable time (step S27; Yes), the production speed is decreased, the deliverable time is recalculated (step S28), and the procedure returns to step S26. If it is determined that the scheduled collection time is not later than the deliverable time (step S27; No), the schedule candidate calculation part 153 (153A) reflects the production speed at that time in a production schedule candidate (step S29), and determines whether there is a production order that has not yet been selected (step S30).

In this step, if there is no production order that has not yet been selected (step S30; No), the production schedule candidate generated so far is output, and the procedure ends. In this case, information indicating that no candidate capable of setting both delays within an acceptable range was found may be output. Conversely, if there is a production order that has not yet been selected (step S30; Yes), the procedure returns to step S24, and a production order with the second priority (production order of the product having the second lowest sensitivity) is selected.

In step S23, if it is determined that the scheduled collection time is not earlier than the deliverable time (step S23; No), the schedule candidate calculation part 153 (153A) selects a production order based on priority in accordance with the sensitivity information (step S31). For instance, in a case where the production schedule includes a plurality of production orders of the product, a production order of the product having a high sensitivity is preferentially selected. The schedule candidate calculation part 153 (153A) recalculates the deliverable time when the production speed of the selected production order is the lower limit speed included in the sensitivity information (step S32).

Here, the schedule candidate calculation part 153 (153A) determines whether both the delay of the deliverable time relative to the scheduled collection time and the delay of the scheduled collection time relative to the deliverable time are in an acceptable range (step S33). That is, in step S33, it is determined whether the first condition is satisfied. In step S33, if it is determined that both delays are in an acceptable range (step S33; Yes), the lower limit speed is reflected in a production schedule candidate, and the procedure ends.

In step S33, if it is determined that at least one of the two delays is out of an acceptable range (step S33; No), the schedule candidate calculation part 153 (153A) determines whether the scheduled collection time is earlier than the deliverable time (step S27). That is, it is determined whether the change amount of the production speed is too large.

If it is determined that the scheduled collection time is earlier than the deliverable time (step S34; Yes), the production speed is increased, the deliverable time is recalculated (step S35), and the procedure returns to step S33. If it is determined that the scheduled collection time is not earlier than the deliverable time (step S34; No), the schedule candidate calculation part 153 (153A) reflects the production speed at that time in a production schedule candidate (step S36), and determines whether there is a production order that has not yet been selected (step S37).

In this step, if there is no production order that has not yet been selected (step S37; No), the production schedule candidate generated so far is output, and the procedure ends. In this case, information indicating that no candidate capable of setting both delays within an acceptable range was found may be output. Conversely, if there is a production order that has not yet been selected (step S37; Yes), the procedure returns to step S31, and a production order with the second priority (production order of the product having the second highest sensitivity) is selected.

The production schedule change system 10 that calculates a production schedule candidate satisfying the first condition using the sensitivity information has been described. Next, the production schedule change system 10 that calculates a production schedule candidate satisfying the first condition and further satisfying at least one of a second condition or a third condition, even not using the sensitivity information, will be described.

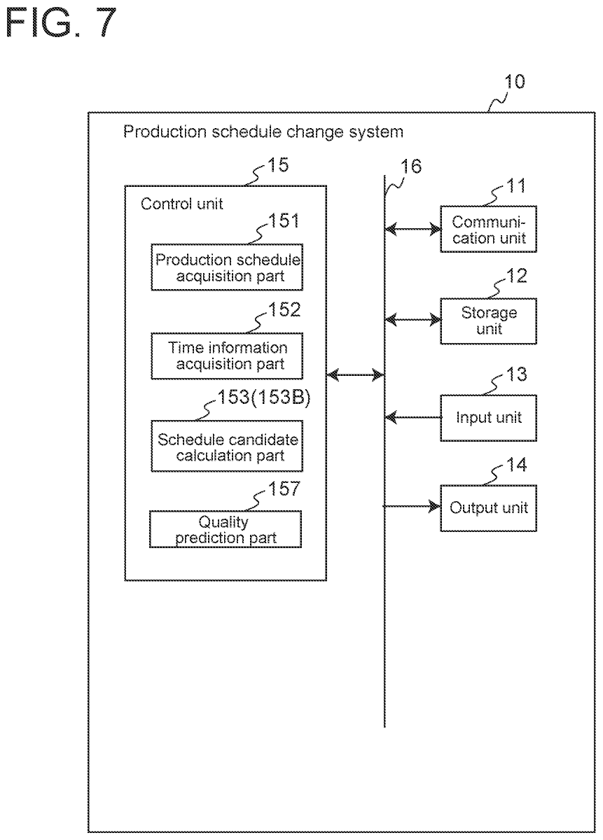

FIG. 7 is a schematic configuration block diagram of the production schedule change system 10 according to an embodiment. As shown in FIG. 7, the production schedule change system 10 includes a schedule candidate calculation part 153 (153B) and a quality prediction part 157. This production schedule change system 10 does not include the quality prediction model generation part 154, the search processing part 155, and the sensitivity information generation part 156 included in the production schedule change system shown in FIG. 1.

The schedule candidate calculation part 153 (153B) calculates at least one production schedule candidate as an alternative to reduce the waiting time of one of the carrier or the resources of the factory. More specifically, the schedule candidate calculation part 153 (153B) changes the production speed from the initial condition within a range defined by the quality standard of the product, based on the time information acquired by the time information acquisition part 152, and calculates at least one production schedule candidate in which one of the delay of the deliverable time relative to the scheduled collection time or the delay of the scheduled collection time relative to the deliverable time of the product is in an acceptable range.

In other words, the schedule candidate calculation part 153 (153B) calculates a production schedule candidate satisfying the first condition and further satisfying at least one of a second condition or a third condition. Here, the first condition is a condition that the time difference between the deliverable time and the scheduled collection time of the product is in an acceptable range. The second condition is a condition that the deliverable time is earlier than the scheduled collection time. The third condition is a condition that the scheduled collection time is earlier than the deliverable time. The schedule candidate calculation part 153 (153B) causes the quality prediction part 157 to predict the quality of the product when the production speed of the production order of the product included in the production schedule is changed from the initial condition, and calculates a production schedule candidate based on the production speed changed based on the prediction result.

The quality prediction part 157 predicts the quality of the product when the production speed of the production order included in the production schedule is changed, based on record information of a previous production order of the product. The record information includes information about a production speed at which the product has been produced and the quality of that product. The quality prediction part 157 may be configured to predict the quality by applying machine learning such as regression analysis to the record information, or may be configured to predict the quality under a predetermined condition.

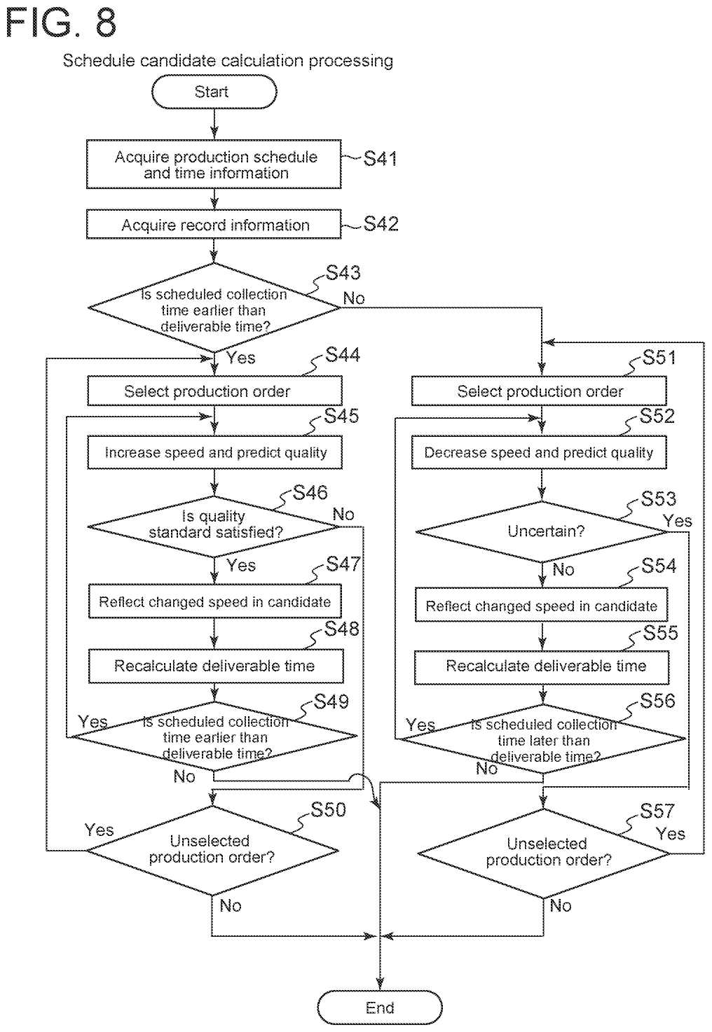

The schedule candidate calculation processing executed by the schedule candidate calculation part 153 (153B) will be described with reference to FIG. 8. FIG. 8 is a flowchart showing an example of the production schedule candidate calculation processing executed by the production schedule change system 10 according to an embodiment.

The schedule candidate calculation part 153 (153B) causes the production schedule acquisition part 151 to acquire a current production schedule (i.e., production schedule when the product is produced at production speed of initial condition), and causes the time information acquisition part 152 to acquire time information indicating the latest scheduled collection time (step S41). Further, the schedule candidate calculation part 153 (153B) acquires record information (step S42). The acquired record information is acquired via the communication unit 11 or the input unit 13 and previously stored in the storage unit 12.

The schedule candidate calculation part 153 (153B) determines whether the scheduled collection time according to the time information is earlier than the deliverable time according to the current production schedule (step S43).

In step S43, if it is determined that the scheduled collection time is earlier than the deliverable time (step S43; Yes), the schedule candidate calculation part 153 (153B) selects a production order included in the production schedule (step S44). For instance, in a case where the production schedule includes a plurality of production orders of the product, a production order scheduled in a time slot close to the time of the selection is preferentially selected. To improve the real-time responsiveness to the schedule change, the schedule candidate calculation part 153 (153B) may be configured to select a production order in progress at the time of selection. The schedule candidate calculation part 153 (153B) causes the quality prediction part 157 to predict the quality when the production speed of the selected production order is increased by a certain amount (step S45).

Here, the schedule candidate calculation part 153 (153B) determines whether the quality of the prediction result satisfies the quality standard (step S46). Whether the quality satisfies the quality standard means whether it falls below the quality standard.

In step S46, if it is determined that the prediction result does not satisfy the quality standard (step S46; No), the schedule candidate calculation part 153 (153B) does not reflect that speed in a production schedule candidate, but determines whether there is a production order that has not yet been selected (step S50).

In this step, if there is no production order that has not yet been selected (step S50; No), the production schedule candidate generated so far is output, and the procedure ends. In this case, information indicating that no candidate satisfying the first condition or the second condition was found may be output. Conversely, if there is a production order that has not yet been selected (step S50; Yes), the procedure returns to step S44, and a production order with the second priority (e.g., next scheduled production order) is selected.

In step S46, if it is determined that the prediction result satisfies the quality standard (step S46; Yes), the schedule candidate calculation part 153 (153B) reflects the changed production speed in a production schedule candidate (step S47), and recalculates the deliverable time based on the changed production speed (step S48).

Here, the schedule candidate calculation part 153 (153B) determines whether the scheduled collection time is earlier than the deliverable time (step S49). If it is determined that the scheduled collection time is not earlier than the deliverable time (step S49; No), the production schedule candidate generated so far is output, and the procedure ends. In other words, even if the delay of the scheduled collection time relative to the deliverable time is out of an acceptable range, since the first condition or the second condition is satisfied, the procedure ends. This means that, if the carrier will collect the product earlier than the original schedule, a candidate that causes waiting time for the resources of the factory is allowed as long as it does not make the carrier waiting.

Conversely, if it is determined that the scheduled collection time is earlier than the deliverable time (step S49; Yes), the schedule candidate calculation part 153 (153B) returns to step S45.

In step S43, if it is determined that the scheduled collection time is not earlier than the deliverable time (step S43; No), the schedule candidate calculation part 153 (153B) selects a production order included in the production schedule (step S51). For instance, in a case where the production schedule includes a plurality of production orders of the product, a production order scheduled in a time slot close to the time of the selection is preferentially selected. The schedule candidate calculation part 153 (153B) causes the quality prediction part 157 to predict the quality when the production speed of the selected production order is decreased by a certain amount (step S52).

Here, the schedule candidate calculation part 153 (153B) determines whether the quality of the prediction result is uncertain (step S53).

In step S53, if it is determined that the prediction result is uncertain (step S53; Yes), the schedule candidate calculation part 153 (153B) does not reflect that speed in a production schedule candidate, but determines whether there is a production order that has not yet been selected (step S57).

In this step, if there is no production order that has not yet been selected (step S57; No), the production schedule candidate generated so far is output, and the procedure ends. In this case, information indicating that no candidate satisfying the first condition or the third condition was found may be output. Conversely, if there is a production order that has not yet been selected (step S57; Yes), the procedure returns to step S51, and a production order with the second priority (e.g., next scheduled production order) is selected.

In step S53, if it is determined that the prediction result is not uncertain (step S53; No), the schedule candidate calculation part 153 (153B) reflects the changed production speed in a production schedule candidate (step S54), and recalculates the deliverable time based on the changed production speed (step S55).

Here, the schedule candidate calculation part 153 (153B) determines whether the scheduled collection time is later than the deliverable time (step S56). If it is determined that the scheduled collection time is not later than the deliverable time (step S56; No), the production schedule candidate generated so far is output, and the procedure ends. In other words, even if the delay of the deliverable time relative to the scheduled collection time is out of an acceptable range, since the first condition or the third condition is satisfied, the procedure ends. This means that, if the carrier will collect the product later than the original schedule, a candidate that causes waiting time for the carrier is allowed as long as it does not make the resources of the factory waiting.

Conversely, if it is determined that the scheduled collection time is later than the deliverable time (step S56; Yes), the schedule candidate calculation part 153 (153B) returns to step S52.

As shown in FIGS. 1 and 6, the production schedule change system 10 according to an embodiment calculates a production schedule candidate satisfying the first condition. As shown in FIGS. 7 and 8, the production schedule change system 10 according to an embodiment calculates a production schedule candidate satisfying the first condition and further satisfying at least one of the second condition or the third condition. These configurations can be combined as appropriate.

Thus, as shown in FIGS. 1 and 6 to 8, the production schedule change system 10 according to some embodiments changes the production speed from the initial condition within a range defined by the quality standard of the product, and calculates at least one production schedule candidate satisfying the first condition that the time difference between the deliverable time and the scheduled collection time of the production is in an acceptable range and further satisfying at least one of the second condition that the deliverable time is earlier than the scheduled collection time or the third condition that the scheduled collection time is earlier than the deliverable time.

With this configuration, a production schedule candidate satisfying the first condition and further satisfying at least one of the second condition or the third condition is calculated. In this case, by applying this candidate, it is possible to effectively reduce the waiting time of the resources of the factory and the waiting time of the carrier. Further, with the above configuration, the production speed is changed from the initial condition within a range defined by the quality standard, and the production schedule candidate is calculated. Thus, it is possible to ensure a minimum quality of the product.

In some embodiments, as shown in FIGS. 1 and 6, in a case where the production schedule includes a plurality of production orders of the product, the schedule candidate calculation part 153 selects a production order that changes the production speed, based on priority in accordance with sensitivity information indicating sensitivity of quality of the product to the production speed for each type of the product.

With this configuration, since the production order that changes the production speed is selected based on priority in accordance with the sensitivity information, it is possible to efficiently calculate the production schedule candidate, and it is possible to easily ensure the quality of the product.

In some embodiments, as shown in FIGS. 1 and 6, in a case where the production schedule includes a plurality of production orders of the product, if the time difference between the deliverable time and the scheduled collection time is out of an acceptable range and the scheduled collection time is earlier than the deliverable time, the schedule candidate calculation part 153 preferentially increases the production speed of a production order of the product having a low sensitivity, recalculates the deliverable time, and calculates a production schedule candidate in which the time difference is in an acceptable range.

With this configuration, since the production speed of the production order of the product having a low sensitivity is preferentially increased, it is possible to prevent a reduction in quality due to an increase in production speed.

In some embodiments, as shown in FIGS. 1 and 6, in a case where the production schedule includes a plurality of production orders of the product, if the time difference between the deliverable time and the scheduled collection time is out of an acceptable range and the scheduled collection time is earlier than the deliverable time, the schedule candidate calculation part 153 preferentially decreases the production speed of a production order having a high sensitivity, recalculates the deliverable time, and obtains a production schedule candidate in which the time difference is in an acceptable range.

With this configuration, since the production speed of the production order of the product having a high sensitivity is preferentially decreased, it is possible to improve the quality with a decrease in production speed.

In some embodiments, as shown in FIGS. 1 and 6, the production schedule change system 10 includes the quality prediction model generation part 154 configured to generate a quality prediction model for predicting the quality of the product in relation to the production speed by using the record information of a previous production order, and the sensitivity information generation part 156 configured to generate or update the sensitivity information by using the generated quality prediction model. The record information includes information about a production speed at which the product has been produced and the quality of that product.

With this configuration, even if the sensitivity information is not generated or needs to be updated, it is possible to generate or update the sensitivity information by using the quality prediction model generated based on the record information of a previous production order.

In some embodiments, the record information further includes at least one of facility information about a production facility that has produced the product, environmental information about an external environment under which the product has been produced, or product information about the product.

In this case, since the record information including various information is used, more accurate sensitivity information is generated, and the production schedule candidate can be calculated using this sensitivity information.

In some embodiments, as shown in FIGS. 7 and 8, the production schedule change system 10 includes the quality prediction part 157 configured to predict the quality of the product when the production speed of the production order of the product is changed, based on the record information of a previous production order. The record information includes information about a production speed at which the product has been produced and the quality of that product. The schedule candidate calculation part 153 causes the quality prediction part 157 to predict the quality of the product when the production speed of the production order of the product included in the production schedule is changed from the initial condition, and calculates a production schedule candidate based on the production speed changed based on the prediction result.

With this configuration, even not using information such as upper limit speed, lower limit speed, and sensitivity, it is possible to calculate a production schedule candidate satisfying the first condition and further satisfying at least one of the second condition or the third condition. However, the system may be configured to use information such as upper limit speed, lower limit speed, and sensitivity to improve efficiency and speed of processing.

In some embodiments, as shown in FIGS. 1 and 6, the production schedule change system 10 includes the search processing part 155 configured to search a range of the production speed defined by the quality standard of the product by using the quality prediction model.

With this configuration, even if the range of the production speed defined by the quality standard of the product is not set, the range can be set by the search processing. Further, since the range of the production speed is searched using the quality prediction model, it is possible to improve efficiency and speed of the search processing.

In some embodiments, the production schedule is a production schedule of corrugated cardboard by a paper converting machine, and the quality standard of the product includes a standard based on at least one quality index of warpage of the corrugated cardboard in a bonded state, folding misalignment of the corrugated cardboard, printing misalignment of the corrugated cardboard, or damage to the corrugated cardboard.

Generally, in the production of corrugated cardboard, various types of products are produced by one production line. Further, the production speed often affects the quality of the products. Corrugated cardboard is expensive to transport compared to product production costs and product prices. Thus, with the above configuration, it is possible to more effectively take advantage of the production schedule change system 10 that reduces waste related to transportation. Further, it is possible to calculate a production schedule candidate taking into consideration a quality index such as warpage, folding misalignment, printing misalignment, and damage important to the production of corrugated cardboard.

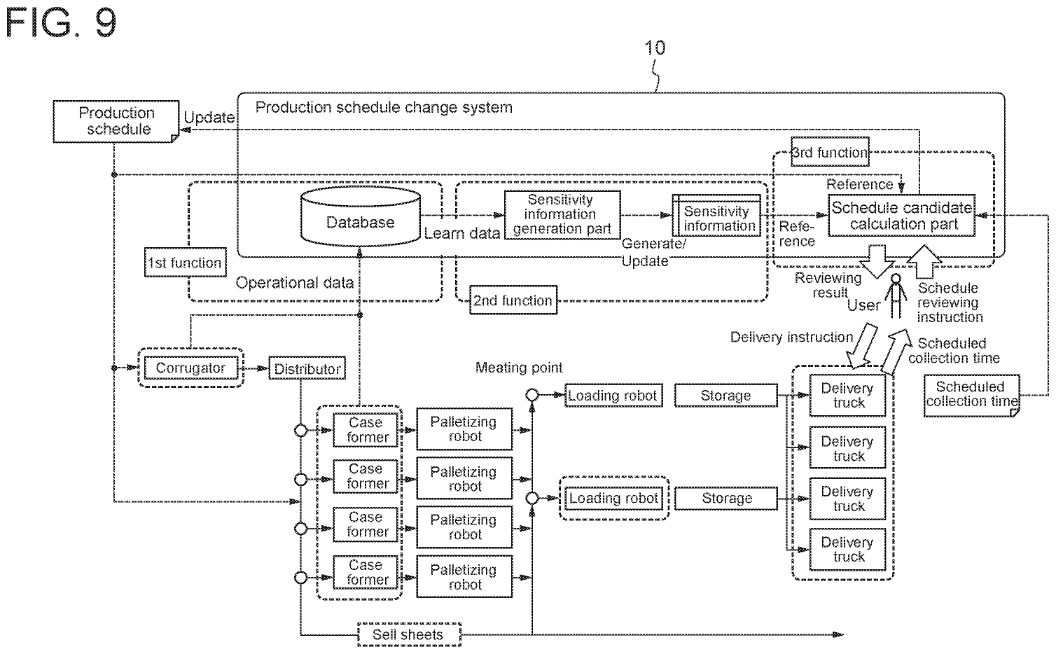

An example of use of the production schedule change system 10 will now be described. FIG. 9 is a schematic diagram for describing an example of use of the production schedule change system 10 according to an embodiment.

As shown in FIG. 9, a factory that produces corrugated cardboard is equipped with a corrugator for producing corrugated cardboard sheets, a case former for assembling corrugated cardboard boxes, and a palletizing robot for stacking the corrugated cardboard boxes. The produced corrugated cardboard boxes are temporarily stored in a storage and shipped by a delivery truck.

As a first function, the production schedule change system 10 collects operational data (e.g., production order, production speed, device setting) from production facilities in the factory and stores the data in one database. The collected operational data may be all data obtainable from the production facilities or may be only data that is used for calculating sensitivity by a second function. The operational data may be stored in the database in real time, or may be stored in the database by collecting data stored in each device at predetermined intervals (e.g., 1 hour, 1 day, 1 week).

The database serves to not only store data used by a second function but also stores the collected operational data as a production log in the factory. A server hosting the database may be an on-premises server installed in the factory or a cloud server installed in a place different from the factory.

As a second function, the production schedule change system 10 acquires data related to sensitivity from each producing device (e.g., corrugator, case former) for each production order to execute machine learning and generate the sensitivity information. The execution of the machine learning and the generation of the sensitivity information may be performed in a time slot for determining the production order of the day, or may be performed at predetermined intervals (e.g., 1 hour, 1 day, 1 week).

As a third function, the production schedule change system 10 receives an instruction from a user who has determined that the production schedule needs to be reviewed, and calculates a production schedule candidate by referring to the time information indicating the current production schedule and the scheduled collection time and the sensitivity information generated by the second function. The production schedule candidate is provided to the user as a reviewing result.

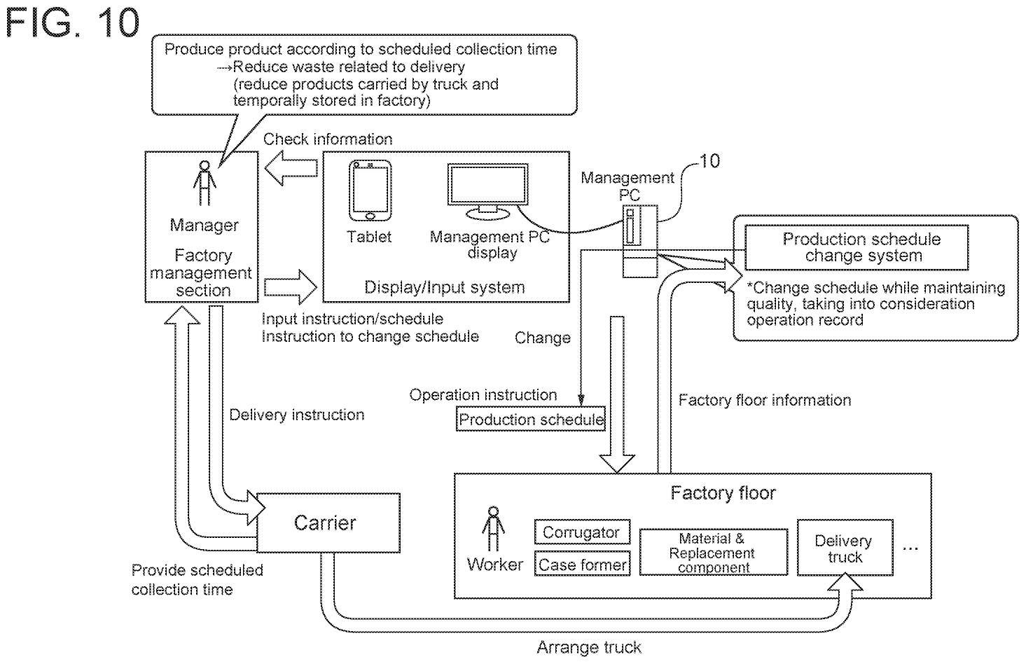

FIG. 10 is a conceptual diagram showing an example of production management using the production schedule change system 10 according to an embodiment. In this example, the production schedule change system 10 is a management personal computer (PC) for production management. In a factory management section, a manager checks information via a display of the production schedule change system 10, inputs an instruction regarding the production schedule to the production schedule change system 10, and sends a delivery instruction to the carrier. The carrier presents the scheduled collection time and arranges a delivery truck to the factory floor.

The production schedule change system 10 outputs an operation instruction based on the production schedule to a worker on the factory floor or to the production facility. If the manager provides an instruction to change the production schedule, the production schedule change system 10 acquires facility information about the corrugator or the case former, inventory information about raw materials or replacement components, and information indicating the collection status of the delivery truck as factory floor information. The production schedule change system 10 calculates a production schedule candidate based on the acquired factory floor information and changes the production schedule based on the candidate. The changed production schedule is output to the worker on the factory floor or to the production facility.

The present invention is not limited to the embodiments described above, but includes modifications to the embodiments described above, and embodiments composed of combinations of those embodiments.

For instance, the schedule candidate calculation part 153 may acquire sensitivity information stored in the database and calculate a production schedule candidate. In this case, since the sensitivity information does not need to be generated and the sensitivity information stored in the database is used, it is possible to increase the speed of processing, and it is possible to improve the responsiveness to a change in the scheduled collection time. In particular, it is advantageous in reviewing the production schedule in real time. The database may be stored in ROM of the storage unit 12 or may be stored in another device.

The schedule candidate calculation part 153 may generate or update the sensitivity information each time the production schedule candidate is calculated, and may calculate a production schedule candidate using this sensitivity information. In this case, since the latest sensitivity information is used, it is possible to precisely calculate the production schedule candidate.

In the production schedule change system 10 shown in FIG. 7, the schedule candidate calculation part 153B is configured not to use the sensitivity information. However, the schedule candidate calculation part 153B may be configured to use the sensitivity information to improve the efficiency of the schedule candidate calculation processing.

The production schedule change system 10 is not limited to a configuration in which the production order that changes the production speed is selected one by one. The production schedule change system 10 may be configured to select a plurality of production orders at once as the production order that changes the production speed. In this case, the change amount of the production speed is divided to the plurality of production orders, so that the influence on the quality can be divided. In addition, calculating the deliverable time by setting the upper limit or the lower limit of the production speed as in the example shown in FIG. 6 is advantageous in that the number of production orders to be changed can be minimized.

The order of processing executed by the production schedule change system 10 is not limited to the order shown in FIGS. 5, 6, and 8. For instance, although in the search processing shown in FIG. 5, the lower limit speed is searched after searching for the upper limit speed, the order may be reversed. In the search processing, other search methods such as simple search or binary search may be applied. In the quality prediction and the search processing based on the record information, sparse modeling technology may be applied. In this case, it is possible to improve the prediction accuracy even when the record information for each product type is little. The processing executed by the production schedule change system 10 is not limited to contents shown in FIGS. 5, 6, and 8, and a part of them may be omitted.

FIGS. 1 and 7 show the configuration in which the production schedule change system 10 is a communication terminal device. However, the production schedule change system 10 is not limited thereto. For instance, when the production schedule change system 10 is a server device, the input unit 13 and the output unit 14 may be eliminated.

In FIG. 6, in step S30, if there is no production order that has not yet been selected (step S30; No), the production schedule candidate generated so far is output, and the procedure ends. In this case, it is found that there is no candidate capable of setting both delays within an acceptable range. However, even in this case, the production speed is changed to the upper limit speed and reflected in the production schedule candidate in steps S25 and S29, and steps S25 and S29 are repeated until there is no unselected production order in step S30. Accordingly, in a range of the production speed where the quality of the product satisfies the quality standard, even if there is no candidate satisfying the first condition that the time difference between the deliverable time and the scheduled collection time is in an acceptable range, it is possible to obtain a production schedule candidate that minimizes the time difference between the deliverable time and the scheduled collection time within the range of the production speed where the quality of the product satisfies the quality standard. In some embodiments, the schedule candidate calculation part 153 of the production schedule change system 10 may be configured to calculate such a candidate in a case where there is no production schedule candidate satisfying the first condition that the time difference between the deliverable time and the scheduled collection time is in an acceptable range.

1. A production schedule change system comprising:
a production schedule acquisition part configured to acquire a production schedule of a product in a case where the product is produced at an initial condition of production speed;
a time information acquisition part configured to acquire time information indicating a scheduled collection time; and
a schedule candidate calculation part configured to:
change the production speed from the initial condition within a range defined by a quality standard of the product, based on the time information; and
calculate at least one candidate of the production schedule,
the at least one candidate satisfying a first condition that a time difference between a deliverable time of the product and the scheduled collection time is in an acceptable range,
the at least one candidate further satisfying at least one of a second condition that the deliverable time is earlier than the scheduled collection time or a third condition that the scheduled collection time is earlier than the deliverable time.

2. The production schedule change system according to claim 1,
wherein in a case where the production schedule includes a plurality of production orders of the product, the schedule candidate calculation part selects a production order that changes the production speed, based on priority in accordance with sensitivity information indicating sensitivity of quality of the product to the production speed for each type of the product.

3. The production schedule change system according to claim 2,
wherein in the case where the production schedule includes the plurality of production orders of the product, if the time difference is out of the acceptable range and the scheduled collection time is earlier than the deliverable time, the schedule candidate calculation part preferentially increases the production speed of a production order of the product having a low sensitivity among the plurality of production orders, recalculates the deliverable time, and calculates a candidate of the production schedule satisfying at least one of the first condition or the second condition.

4. The production schedule change system according to claim 2,
wherein in the case where the production schedule includes the plurality of production orders of the product, if the time difference is out of the acceptable range and the scheduled collection time is later than the deliverable time, the schedule candidate calculation part preferentially decreases the production speed of a production order of the product having a high sensitivity among the plurality of production orders, recalculates the deliverable time, and calculates a candidate of the production schedule satisfying at least one of the first condition or the third condition.

5. The production schedule change system according to claim 2,
wherein the schedule candidate calculation part acquires the sensitivity information stored in a database and calculates a candidate of the production schedule.

6. The production schedule change system according to claim 2, comprising:
a quality prediction model generation part configured to generate a quality prediction model for predicting quality of the product in relation to the production speed, based on record information of a previous production order; and
a sensitivity information generation part configured to generate or update the sensitivity information using the generated quality prediction model,
wherein the record information includes information about a production speed at which the product has been produced and quality of the product.

7. The production schedule change system according to claim 6,
wherein the record information further includes at least one of facility information about a production facility that has produced the product, environmental information about an external environment under which the product has been produced, or product information about the product.

8. The production schedule change system according to claim 1, comprising a quality prediction part configured to predict quality of the product in a case where the production speed of a production order included in the production schedule is changed, based on record information of a previous production order of the product,
wherein the record information includes information about a production speed at which the product has been produced and quality of the product, and
wherein the schedule candidate calculation part causes the quality prediction part to predict quality of the product in a case where the production speed of the production order of the product included in the production schedule is changed from the initial condition, and calculates the production schedule based on the production speed changed based on a prediction result as the at least one candidate.

9. The production schedule change system according to claim 1, comprising a search processing part configured to search for a range of the production speed defined by the quality standard of the product, using a quality prediction model for predicting quality of the product in relation to the production speed.

10. The production schedule change system according to claim 1,
wherein the production schedule is a production schedule for producing corrugated cardboard by a paper converting machine, and
wherein the quality standard of the product includes a standard based on at least one quality index of warpage of the corrugated cardboard in a bonded state, folding misalignment of the corrugated cardboard, printing misalignment of the corrugated cardboard, or damage to the corrugated cardboard.

11. The production schedule change system according to claim 1,
wherein, if no candidate of the production schedule satisfying the first condition is found, the schedule candidate calculation part calculates a candidate that minimizes the time difference between the deliverable time and the scheduled collection time within a range of the production speed defined by the quality standard of the product.

12. A production schedule change method comprising:
a production schedule acquisition step of acquiring a production schedule of a product in a case where the product is produced at an initial condition of production speed;
a time information acquisition step of acquiring time information indicating a scheduled collection time; and
a schedule candidate calculation step of:
changing the production speed from the initial condition within a range defined by a quality standard of the product, based on the time information; and
calculating at least one candidate of the production schedule,
the at least one candidate satisfying a first condition that a time difference between a deliverable time of the product and the scheduled collection time is in an acceptable range,
the at least one candidate further satisfying at least one of a second condition that the deliverable time is earlier than the scheduled collection time or a third condition that the scheduled collection time is earlier than the deliverable time.

13. A production schedule change program configured to cause a computer to function as:
a production schedule acquisition unit configured to acquire a production schedule of a product in a case where the product is produced at an initial condition of production speed;
a time information acquisition unit configured to acquire time information indicating a scheduled collection time; and
a schedule candidate calculation unit configured to:
change the production speed from the initial condition within a range defined by a quality standard of the product, based on the time information; and
calculate at least one candidate of the production schedule,
the at least one candidate satisfying a first condition that a time difference between a deliverable time of the product and the scheduled collection time is in an acceptable range,
the at least one candidate further satisfying at least one of a second condition that the deliverable time is earlier than the scheduled collection time or a third condition that the scheduled collection time is earlier than the deliverable time.
